(19) United States
(12) Patent Application Publication
(10) Pub. No.: US 2004/0158182 A1
(43) Pub. Date: Aug. 12, 2004

(54) Hemorrhoid treatment and prostrate massage apparatus

(76) Inventor: Jiro Takashima, Houston, TX (US)

Correspondence Address: John S. Egbert, Harrison & Egbert, 7th Floor, 412 Main Street, Houston, TX, 77002, US

(21) Appl. No.: 10/424,015

(22) Filed: Apr. 28, 2003

Related U.S. Application Data
(63) Continuation-in-part of application No. 09/883,900, filed on Jun. 19, 2001, now Pat. No. 6,589,193.
Application No. 09/883,900 is a continuation-in-part of application No. 09/675,436, filed on Sep. 29, 2000.

(51) Int. Cl. A61H 21/00

(52) U.S. Cl. 601/135; 601/137

(57) ABSTRACT

An apparatus for massaging hemorrhoids through the contraction of a human sphincter including a head having a size suitable for fitting into a human rectum and through the sphincter and a resistor connected to an end of the head. The head has a bulbous portion and a tapered section extending from the bulbous portion. The tapered section narrows in diameter from the bulbous portion. The resistor has a tapered surface in which the average taper widens from the end of the head to a wide portion of the resistor. A tail is connected to an opposite end of the resistor. A portion of the tapered section of the head has a diameter equal a diameter of a widening tapered surface of the tail as separated by the length of the sphincter.

### RELATED U.S. APPLICATIONS

The present application is a continuation-in-part of U.S. patent application Ser. No. 09/883,900, filed on Jun. 19, 2001, and entitled “HEMORRHOID TREATMENT AND PROSTRATE MASSAGE APPARATUS”. U.S. patent application Ser. No. 09/883,900 is a continuation-in-part of U.S. patent application Ser. No. 09/675,436, filed on Sep. 29, 2000, and entitled “PROSTRATE MASSAGE APPARATUS”. U.S. patent application Ser. No. 09/883,900 is presently pending.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention relates to apparatus for the treatment of hemorrhoids. More particularly, the present invention relates to plug-type apparatus that can be inserted through the human rectum for massaging the prostrate gland and for the purpose of the treatment of hemorrhoids. Additionally, the present invention relates devices for massaging internal and external hemorrhoids by the self-movement of the device.

Additionally, and furthermore, the present invention relates to devices that are movably held by the lateral pressure of the sphincter muscles inside the anal canal so as to induce the involuntary peristaltic movement of the surface muscles of the anal canal so as to massage internal and external hemorrhoids.

### BACKGROUND OF THE INVENTION

One treatment for non-bacterial disorders of the prostate such as chronic prostatitis and a congested prostate is the prostate massage. Some urologists believe that the most effective treatment for such prostatitis is for the doctor to massage the prostate at regular intervals. Other urologists are far less enthusiastic about this procedure, and some do not believe in it at all. To perform such a massage, the physician simply inserts a gloved finger into the rectum and strokes the prostate very gently. It serves to relieve the symptoms of chronic prostatitis by draining accumulated prostatic fluid from the glands and ducts.

Given the difference of opinion of urologists as to the need for prostatic massages, such massages can be difficult to obtain. In any event, the regular and repeated massaging of the prostate can often require frequent visits to the doctor's office. This causes the patient to incur a considerable expense and inconvenience. As such, a need has developed for allowing an individual to carry out his own prostatic massage.

Hemorrhoids can be of severe pain to the individual. In may circumstances, external medicines are applied to the hemorrhoid for the treatment of such hemorrhoidal tissues. However, the external application of such medicines is only moderately effective in the treatment and remedying of severe hemorrhoidal conditions. It is believed that a hemorrhoid massage is most effective in stimulating blood flow in the area of the hemorrhoidal tissues. Heretofore, no device has been developed which effectively stimulates blood flow in such area.

In the past, some patents have issued relating to rectal devices. U.S. Pat. No. 4,542,753, issued on Sep. 24, 1985 to Brenman et al., describes an apparatus and method for stimulating penile erectile tissue. In this invention, a body is provided which may be inserted into the rectum of a user. The body is shaped so as to closely conform to the topological configuration of the rectum within the anal area to a site adjacent to the prostate gland. Electrical circuitry for generating a neurally stimulating electrical signal is located within the body. Electrodes, placed at particular locations on the surface of the body, apply the signal to the user. At least one of the electrodes closely contacts the prostate gland when the body member is operatively disposed, at a region or spot on the prostate gland previously determined to be sensitive to electrical stimulation.

U.S. Pat. No. 5,404,881, issued on Apr. 11, 1995 to Cathaud et al., describes a trans-rectal probe. This trans-rectal probe includes a probe body made of a flexible self-supporting polymer material whose degree of flexibility is designed to enable it to comply with the shape of the rectum while having substantially no compression effect on the rectum when inserted therein. The invention makes it possible to achieve accurate, safe and reliable positioning of an instrument for detection or therapeutic treatment level with the organ to be observed or treated. In particular, this device is designed for treatment of the prostate.

U.S. Pat. No. 2,478,786, issued on Aug. 9, 1949 to H. M. Smallen, describes a prostate gland massaging implement. This implement includes a lever having an interior handle which constitutes a power arm to extend down in front of the abdomen and a substantially horizontal portion extending under the groin and offset laterally to avoid the genital organs. The implement has an upwardly and forwardly bent posterior portion which forms the work arm. This work arm extends into the rectal passage to bear across the frontal wall thereon adjacent the prostate gland. The bent portion between the horizontal and the posterior portions serves as a fulcrum point against the front wall of the rectal opening when the implement is subject to pivotal movement around this point.

The present inventor has two U.S. patents showing devices for releasing congested prostate fluid. U.S. Pat. No. 5,797,950, issued on Aug. 25, 1998, describes such a device including a head having a size suitable for fitting in a human rectum and through a sphincter. The head has a size suitable for rubbing the prostate gland. A rod is connected to the bottom of the head and extends outwardly therefrom. The rod serves to position the head and guide a movement of the head as the sphincter contracts and relaxes. An abutment surface is affixed to the rod distal the head. The abutment surface contacts the perineum area and pushes up on the perineum area as the sphincter contracts. The rod is a rigid rod having a generally L-shaped or Comprising:-shaped configuration with a radius of curvature such that the head tilts toward the prostate gland as the sphincter contracts and draws the head upwardly. The head has a generally ellipsoidal shape.

U.S. Pat. No. 5,861,009, issued on Jan. 19, 1999 to the present inventor, describes an apparatus for releasing congested prostate fluid having a head with a size suitable for fitting into a human rectum and through the sphincter and having a surface for pushing on the prostate gland. A rod is connected to the bottom of the head and extends outwardly therefrom so as to guide a movement of the head as the sphincter relaxes and contracts. An abutment member is positioned on the rod opposite the head so as to push on the perineum area simultaneously with the head pushing on the prostate gland. The abutment member has a variable angular relationship with the head.

In each of these prior art patents to the present inventor, the rod movably holds the head within the sphincter, and when the external sphincter contracts, the lateral pressure of the external sphincter drives the head upwardly and the rod adds pressure against the perineum area simultaneously. The power of the sphincter's contraction is divided into one for pressure on the prostate and one for pressure onto the perineum area. Under certain circumstances, some persons have felt that the perineum pressure by this rod was strong and uncomfortable.

It is an object of the present invention to provide a prostrate massage apparatus which increases blood flow for treating hemorrhoidal tissues.

It is another object of the present invention to provide a hemorrhoidal treatment apparatus which allows persons to carry out self-massages of the prostrate and the hemorrhoidal tissues so as to increase blood flow in the hemorrhoidal tissues and to express fluid from the congested prostrate.

It is another object of the present invention to provide a hemorrhoidal treatment apparatus that utilizes a combination of elements within the sphincter canal so as to induce peristaltic movement of the surface of the sphincter muscles so as to cause energy consumption inside the sphincter for increasing in blood circulation of the area.

It is a further object of the present invention to a provide hemorrhoidal treatment apparatus which is safe, easy to use and relatively inexpensive.

It is another object of the present invention to provide a hemorrhoidal treatment apparatus that can provide massage and stimulation regardless of the direction in which the apparatus is inserted into the human rectum.

These and other objects and advantages of the present invention will become apparent from a reading of the attached specification and appended claims.

### BRIEF SUMMARY OF THE INVENTION

The present invention is a hemorrhoidal message device comprising a head having a size suitable for fitting into a human rectum and through the anal sphincter, a resistor connected to an end of the head, and a tail connected to an end of the resistor. The head has a bulbous portion and a tapered section extending from the bulbous portion. The tapered section narrows in diameter from the bulbous portion. The resistor has a spindle shape with a first tapered surface widening from the end of the head so as to define a wide portion of the resistor. The wide portion of the resistor is approximately one-half inch in diameter. The resistor has a second tapered surface extending and narrowing from the wide portion of the first tapered surface. The tail has a widening tapered surface extending from the end of the resistor. A portion of the tapered section of the head has an equal diameter relative to a portion of the widening tapered surface of the tail where the portion of the widening tapered surface of the tail is separated by a distance of between 1 and 1½ inches from the portion of the tapered surface of the head. The device has a length of between 3 and 4 inches.

### BRIEF DESCRIPTION OF THE SEVERAL VIEWS OF THE DRAWINGS

FIGS. 1 and 2 are side elevational views of a preferred embodiment of the hemorrhoid massage device of the present invention.

FIGS. 3-5 show the motion of the hemorrhoid massage device of the present invention between inward and outward movements.

### DETAILED DESCRIPTION OF THE INVENTION

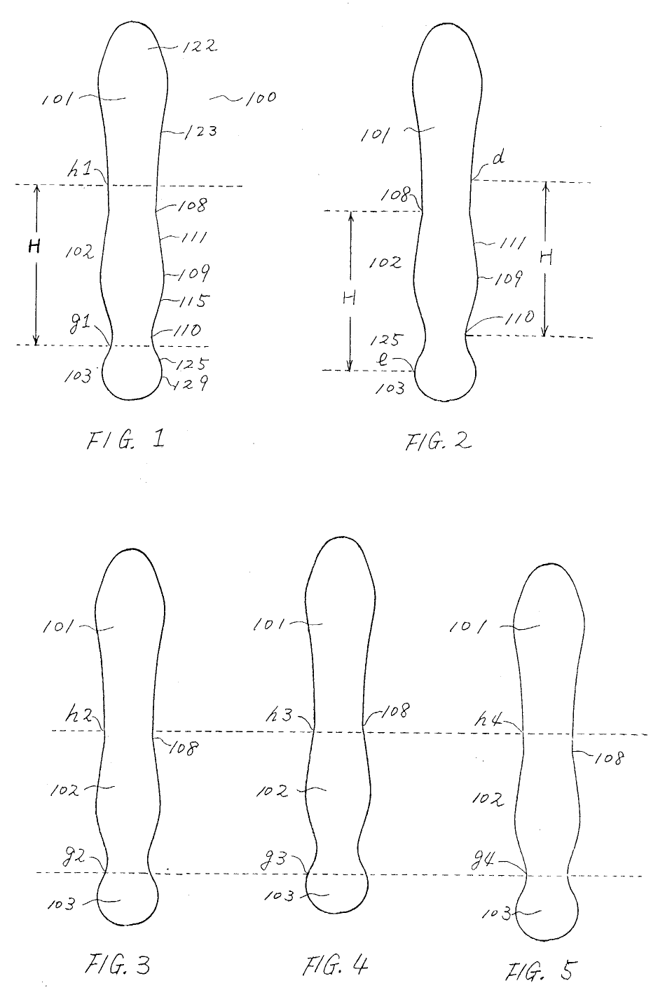

Referring to FIG. 1, there is shown the hemorrhoid massage device 100 in accordance with the teachings of the preferred embodiment of the present invention. Hemorrhoid massage device 100 includes a resistor 102 with a head 101 connected to one end 108 of the resistor 102 and a tail 103 connected to an opposite end 110 of the resistor 102.

In the present invention, the resistor 102 has a spindle shape. The first tapered surface 111 widens from the end 108 of the resistor 102 to the wide portion 109 of the resistor 102. The second tapered surface 115 narrows from the wide portion 109 of the resistor 102 to the opposite end (i.e., the diametero FIGURE the wide section 109 of the resistor 102 is less than a third of the length of the sphincter so as to induce a peristaltic motion on the surface of the anal sphincter. As such, the diameter of the wide section 109 of the resistor 102 is approximately ⅜ inch to ½ inch. The diametric difference between the wide section 109 of the resistor 102 and the ends 108 and 110 of the resistor 102 is less than 0.2 inches. The diameter of each of the ends 108 and 110 of the resistor 102 can be equal or different depending on which end of the resistor 012 is positioned nearer to the upper edge (h) or the lower edges (g) of the sphincter 110 of the resistor 102. The length of the resistor is shorter than the length of the human sphincter between 0.5 inch and 1.25 inches.)

The head 101 has a bulbous portion 122 and a narrowing tapered section 123 extending from the bulbous portion 122 of the head 101 to the top 108 of the resistor 102.

The tail 103 has a widening tapered surface 125 from the opposite end 110 of the resistor 102.

FIG. 1 shows that the diameter of the opposite end 110 of the resistor 102 is smaller than the diameter of the end 108 of the resistor 102. The angle of taper of the tapered surface 125 of the tail 103 is greater than the tapered angle of the tapered surface 123 of the head 101. By this arrangement, the opposite ends 110 of the resistor can be positioned closer to the lower edge (g) of the sphincter.

The tapered section 123 of the head 101 has a portion h1 and the tapered surface 125 of the tail 103 has a portion (g1), with the portion (g1) and the portion (h1) separated by 1 to 1.5 inches. As a reference herein, the length of the human sphincter will be between 1 and 1.5 inches, depending of the size of the individual. In view of the variations of size and condition of the human organs, the dimensions recited herein can be varied by ±20%.

The diameter at the portion (h1) of the tapered section 123 of the head 101 has an equal diameter to the portion (g1) of the tapered surface 125 of the tail 103. The preferred diameter at the widest section 129 of the tail 103 is less than ⅛ inch longer than the diameter at the portion (g1) of the tail 103.

FIG. 2 shows that the diameter of the end 108 of the resistor 102 is smaller than the diameter (e) of the tapered surface 125 of the tail 103 separated by 1.5 inches (distance H) from the end 108 of the resistor 102. Similarly, the diameter of the opposite end 110 of the resistor 102 is smaller than the diameter at the portion (d) of the head 101 separated by 1.5 inches (distance H′) from the opposite end of the resistor 102.

FIG. 3 shows the first position of the device 110 of the present invention. The device 110 is inserted into the anal canal and maintains a balanced position. The broken line (g) shows the lower edge of the anal sphincter and the broken line (h) shows the upper edge of the anal sphincter. When the diameter of the device 110 at the upper edge (h2) of the sphincter is equal to the diameter of the device at the lower edge (g2) of the sphincter, and the lateral pressure of the sphincter is distributed equally throughout the entire area of the sphincter, the thrust force added to the device by the lateral pressure of the anal sphincter is balanced across the device.

When the device is in this balanced position within the anal sphincter, it receives many kinds of forces. These forces can include a wave-like peristaltic motion, lateral pressure, and evacuative pressure. The various surfaces of the spindle-shape resistor convert these forces to directional thrust forces.

FIG. 4 illustrates the device 110 as pushed upwardly to a second position by unbalanced forces. When peristaltic motion is added to the second tapered surface 115 of the resistor 102, the device 110 will move upwardly. This makes the diameter of the device 110 at the upper edge (h3) of the sphincter is smaller than the diameter of the device 110 at the lower edge (g3) of the sphincter. The lateral pressure of the sphincter then pulls the device back to the first position (illustrated in FIG. 3)

FIG. 5 shows the device as pushed down to a third position by either voluntary or involuntary evacuative pressure. The diameter of the head at the upper edge (h4) of the sphincter becomes larger than the diameter of the tail at the lower edge (g4) of the sphincter. The lateral pressure of the sphincter then pushes the device upwardly to the first balanced position and so on. These continuous small movements help to massage the hemorrhoidal tissues and to increase blood circulation to the area.

The foregoing disclosure and description of the invention is illustrative and explanatory thereof. Various changes in the details of the illustrated apparatus can be made within the scope of the appended claims without departing from the true spirit of the present invention. The present invention should only be limited by the following claims and their legal equivalents.

I claim:

1. A hemorrhoid message device comprising:
a head having a size suitable for fitting into a human rectum, said head having a bulbous portion and a tapered section extending from said bulbous portion;
a resistor connected to an end of said head, said resistor having a spindle shape with a first tapered surface widening from an end of said resistor so as to define a wide portion of said resistor, said resistor having a second tapered surface narrowing from said wide portion of said resistor to an opposite end of said resistor, said tapered section of said head narrowing in diameter toward said end of said resistor; and
a tail connected to said opposite end of said resistor, said tail having a widening tapered surface extending from said opposite end of said resistor toward an end of said tail, a portion of said tapered section of said head having an equal diameter at said widening tapered surface of said tail where said portion of said widening tapered surface of said tail is separated by a distance of between 1 and 1.5 inches inclusive from said portion of said tapered surface of said head.

2. The device of claim 1, a length from an end of said head opposite said resistor to said end of said tail is less than 4 inches.

3. The device of claim 1, a maximum diameter at said wide portion of said resistor is less than ½ inch.

4. The device of claim 1, a diameter of said wide section of said resistor is less than 0.20 inch grater than a diameter of each of said ends of said resistor.

5. The device of claim 1, said opposite end of said resistor having a diameter no greater than a diameter of said head at a distance of 1.5 inches from said opposite end of said resistor.

6. The device of claim 1, said end of said resistor having a diameter no greater than a diameter of said tail at a distance of 1.5 inches from said end of said resistor.

7. The device of claim 1, a diameter of a widest section of said tail being less than 0.2 inch larger than said portion of said widening tapered surface of said tail.

8. The device of claim 1, said widening tapered surface of said tail and said widening tapered surface of said head each having an angle of taper, a diameter of said end of said resistor being smaller than a diameter of said opposite end of said resistor, the angle of taper of said widening tapered surface of said tail is greater than the tapered angle of said head.

9. The device of claim 1, said widening tapered surface of said tail and said widening tapered surface of said head each having an angle of taper, a diameter of said end of said resistor being smaller than a diameter of said opposite end of said resistor, the angle of taper of said head being greater than the angle of taper of said tail.

10. A hemorrhoid massage device comprising:
a head having a size surface for fitting into a human rectum, said head having a bulbous portion and a tapered section extending from said bulbous portion;
a resistor connected to an end of said head, said resistor having a spindle shape with a first tapered surface widening from an end of said head so as to define a wide portion of said resistor, said resistor having a second tapered surface extending and narrowing from said wide portion of said resistor to an opposite end of said resistor, said tapered section of said head narrowing in diameter toward said end of said resistor; and
a tail connected to said opposite end of said resistor, said tail having a widening tapered surface extending from said opposite end of said resistor toward an end of said tail, a portion of said tapered section of said head having an equal diameter at said widening tapered surface of said tail where said portion of said widening tapered surface of said tail is separated by a distance of between 1 and 1.5 inches inclusive from said portion of said tapered surface of said head, a diameter of said opposite end of said resistor being smaller than a diameter of said end of said resistor, an angle of taper of said widening tapered surface of said tail being greater than an angle of taper of said tapered surface of said head, a diameter of said wide portion of said resistor being less than ½ inch.
